(19) United States
(12) Patent Application Publication
(10) Pub. No.: US 2024/0418554 A1
(43) Pub. Date: Dec. 19, 2024

(54) Material Indicating Gauge

(71) Applicants: Mark Deem, Parkersburg, WV (US); Michael Deem, Parkersburg, WV (US); LIT Solutions Worldwide LLC, Parkersburg, WV (US)

(72) Inventors: Mark Deem, Parkersburg, WV (US); Michael Deem, Parkersburg, WV (US)

(21) Appl. No.: 18/337,353

(22) Filed: Jun. 19, 2023

(51) Int. Cl. G01F 23/00

(52) U.S. Cl. CPC G01F 23/0007; H05B 45/12

(57) ABSTRACT

A material indicating gauge for the monitoring of multiple fluids in a single container. The material indicating gauge comprises a power supply, a circuit, and an addressable light emitting diode (LED) strip. The circuit further comprises an LED driver, a step-down converter, and a microcontroller. The microcontroller receives input signals transmitted from the internal monitoring system of the containers. The microcontroller processes the input signals and transmits output signals to the addressable LED strip. The addressable LED strip visually marks the height of the fluids within the container. The addressable LED strip can also signal when the container is near maximum levels or near minimum levels by flashing or the like. The circuit includes a wireless adapter for wireless communication with a mobile device or computer. An app on the mobile device can communicate the fluid levels within the container.

### FIELD OF THE INVENTION

The present invention relates generally to a material indicating gauge and more specifically to a material indicating gauge in a storage tank with at least two fluids.

### BACKGROUND OF THE INVENTION

Material indicating gauges for determining fluid levels in the prior art are well known and documented. Most of the prior art deals with a single fluid within a container. The gauges monitor a single fluid and for a single container configured for that particular gauge. One would need to purchase the container along with the gauge in order to monitor the fluid level. If the container is relatively large such as oil tanks for storage at oil terminals, the containers can be expensive and take time to make. Also, the gauges in the prior art are typically indicator lights that are spaced along the height of the container. The spacing of the lights is sometimes quite extensive and the exact height of the fluid is not known until the height of the fluid rises or lowers and triggers a light to go on or off, respectively. Other prior art discloses lights to illuminate the fluid to show the fluid level. The container would need to be at least partially translucent for an observer to be able to remotely visualize the fluid level.

An objective of the present invention is to provide a material indicating gauge that can monitor the level of a fluid in a container and give an external visual marker of the lever.

Another objective of the present invention is to provide a gauge that can mount on any container needing monitoring of the contents in a container. The present invention is to provide a system for connecting to the container monitoring system and to give visual markers of fluid levels in the container.

Another objective of the present invention is to provide a gauge that gives a continuous visual reading to know the precise level of fluid.

Another objective of the present invention is to provide a gauge that monitors more than one fluid in a single container such as oil and water.

### SUMMARY OF THE INVENTION

A material indicating gauge for the monitoring of multiple fluids in a single container comprises an electrical power supply, a circuit, and an addressable light emitting diode (LED) strip. The circuit further comprises an LED driver, a step-down converter, and a microcontroller. The microcontroller receives input data signal transmitted from the internal monitoring system of the containers. The microcontroller processes the input data signal and transmits output signals to the addressable LED strip. The addressable LED strip visually marks the height of the fluids within the container. The addressable LED strip can also signal when the container is near maximum levels or near minimum levels by sending out warning signals such as the addressable LED strip flashing. The circuit also includes a wireless adapter for wireless communication with a mobile device or computer. An app on the mobile device can communicate the fluid levels within the container through the app so that the observer can have remote visual indication of the fluid levels within the container. The app can also communicate other parameters of the system such as valves open and close positions, as well as temperature and other data.

### BRIEF DESCRIPTION OF THE DRAWINGS

FIG. 1 is a perspective view of the present invention, in accordance with some embodiments.

FIG. 2 is a front perspective view of the inside of the housing showing the circuit, in accordance with some embodiments.

FIG. 3 is a block diagram of the present invention, in accordance with some embodiments.

FIG. 4 is a block diagram of the present invention, in accordance with some embodiments.

FIG. 5 is a perspective view of the present invention installed on a storage container and storage container support, in accordance with some embodiments.

FIG. 6 is an exploded view of the light emitting diode (LED) strip, in accordance with some embodiments.

FIG. 7 is a block diagram of communication paths of the storage container internal monitoring system and the present invention, in accordance with some embodiments.

### DETAIL DESCRIPTIONS OF THE INVENTION

All illustrations of the drawings are for the purpose of describing selected versions of the present invention and are not intended to limit the scope of the present invention.

As used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

“First”, “second” etc. as contained herein are terms used as labels for nouns that the labels precede and do not imply ordering unless context deems otherwise.

The specifications include references to an “exemplary embodiment” which do not necessarily refer to the same embodiment. The specifications include references to “some embodiments” or “some other embodiments” which do not in either case necessarily refer to the same embodiment unless otherwise stated.

The present disclosure has broad utility and application. Any embodiment may incorporate only one of a plurality of the disclosed aspects of the present invention and may further incorporate only one or a plurality of the disclosed features of the present invention.

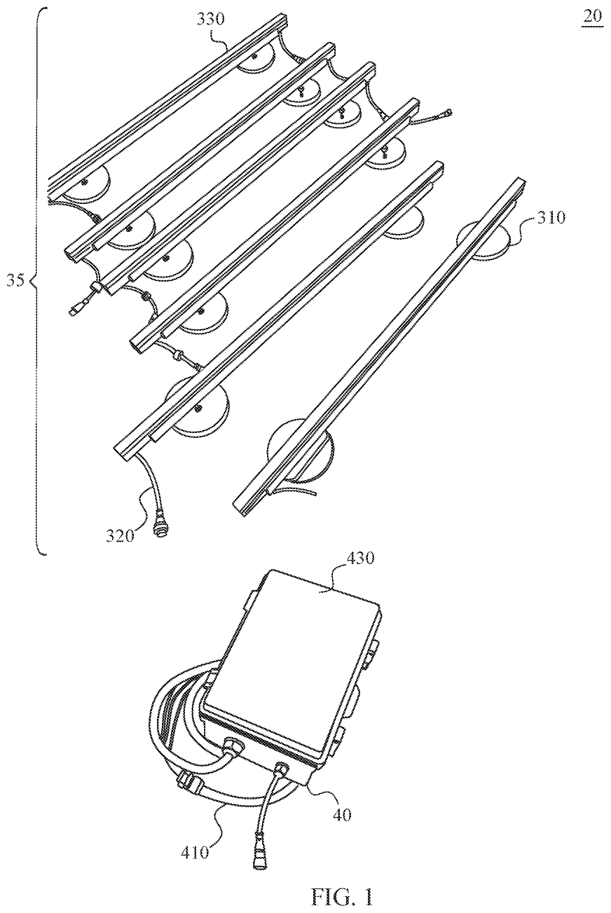

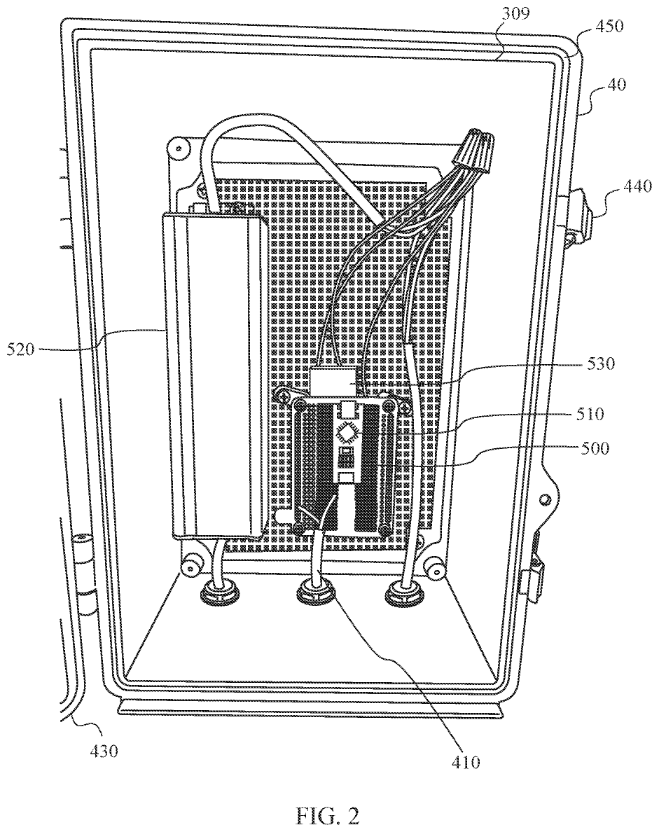

Referring to FIG. 1 and FIG. 2, a material indicating gauge 20 as disclosed herein comprises an electrical power supply 580, a housing 40, a circuit 50, and an addressable light emitting diode (LED) strip 30. The electrical power supply 580 may be an alternating current (AC) power source or a direct current (DC) power source. The housing 40 further comprises a door seal 450, a housing door 430, and a door latch 440. The present invention further comprises one or more cables 410. One of the one or more cables 410 are for transmission of power or data or the like. The circuit 50 is disposed in the housing 40. The door seal 450 is disposed perimetrically around the housing. The housing door 430 and door latch 440 are engaged with the housing 40 to enclose the circuit 50 within the housing 40. The door seal 303 is disposed perimetrically around a peripheral edge 309 of the housing 40; The housing door 430, the door seal 450, and the housing 40 are configured to be waterproof. The housing 40 operably receives the housing door 430 with the door seal 450 disposed between said housing 40 and said housing door 430. The housing 40 The housing 40 further comprises one or more cable holes. One of the one or more cable holes receives the one of the one or more cables 410 to allow connection of one of the one or more cables 410 to the various components of the circuit 50. One of the one or more cable holes may also receive one of one or more electrical cord grips to protect the one of the one or more cables 410 from being damaged from an edge of one of the one or more cable holes. The ends of one of the one or more cables may include connectors that allow for simple plug and play install.

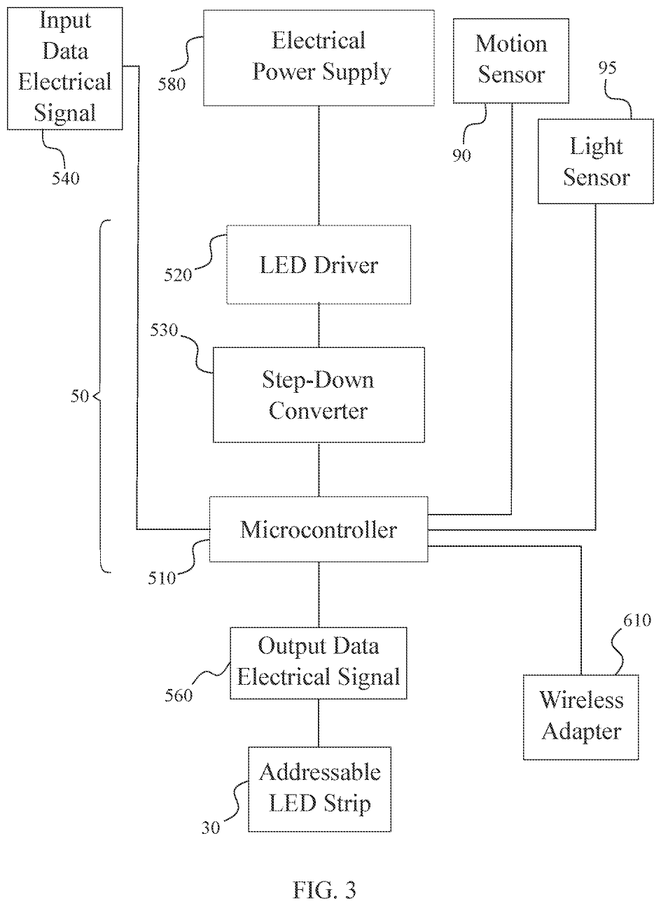

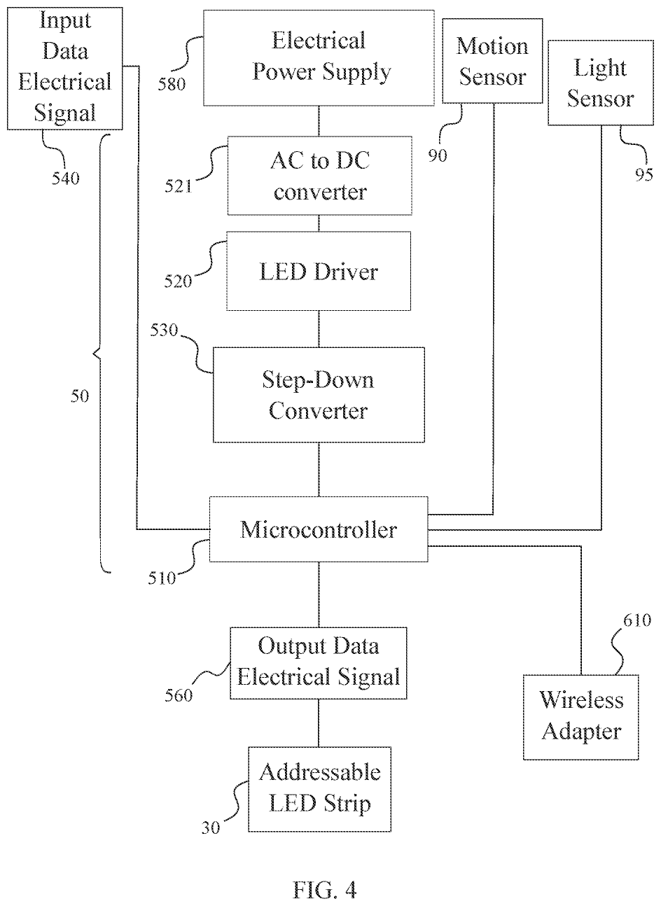

As shown in FIG. 2 and FIG. 3, the circuit 50 further comprises an LED driver 520, a step-down converter 530, and a microcontroller 510. The LED driver 520 further comprises an input side, and an output side. The electrical power supply 580 is electrically coupled to the input side for the LED driver 520 for transmission of power. The output side of the LED driver 520 is electrically coupled to the step-down converter 530 for the transmission of DC power. The LED driver 520 is further electrically coupled to the addressable LED strip 30 for the transmission of DC power. FIG. 4 shows a block diagram of an exemplary embodiment of the present invention. If the electrical power supply 580 is the AC power source, the circuit 50 further comprises an AC to DC converter 521. The AC to DC converter 521 is electrically connected to electrical power supply and input side of the LED driver 520. In some embodiments, the AC to DC converter 521 is electrically integrated with the LED driver 520. The LED driver 520 regulates electrical power to the addressable LED strip 30 thereby limiting possibilities of overloading the addressable LED strip 30 and damaging the addressable LED strip 30.

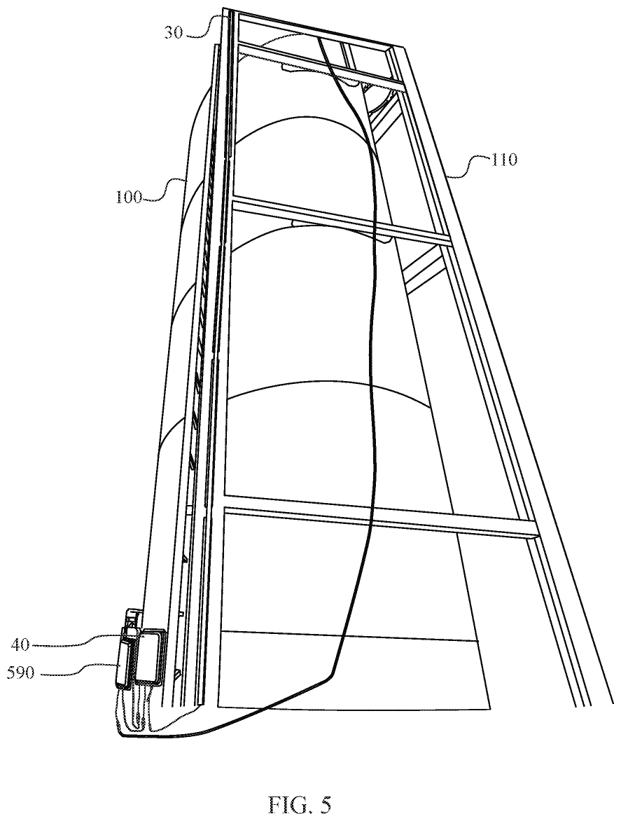

In an exemplary embodiment, FIG. 5 shows the present invention attached to a storage tank 100 according to some embodiments. The storage tank 100 may include a fluid column. The fluid column may comprise one or more fluids separated by physical characteristics of the one or more fluids. The physical characteristics may include density as the physical characteristic used to separate but is not limited to this. One or more fluids such as oil and water can be separated by density within the fluid column. One of the fluids may comprise a liquid, a gas, a plurality of particles, or the like. The storage tank 100 further comprises an internal monitoring system. The internal monitoring system is electrically coupled to the microcontroller 510 by one of the one or more cables 410. The internal monitoring system transmits an input data electrical signal 540 to the microcontroller 510. The internal monitoring system may comprise a float system. The float system may comprise one or more floats. One of the one or more floats is configured to be buoyant to one of the one or more fluids. One of the one or more floats may include a sensor that transmits the input data electrical signal 540 of its height relative to a sensor attached to a calibrated position on the storage tank 100 but is not limited to this. In some embodiments, the input data electrical signal 540 can be transmitted wirelessly.

Referring again to FIG. 3, the step-down converter 530 converts DC voltage from the LED driver 520 to a relatively lower DC voltage compatible with the microcontroller 510. The step-down converter 530 is electrically coupled to the microcontroller 510. The microcontroller 510 is programmable in order to receive the input data electrical signal 540. The microcontroller 510 processes the input data electrical signal 540 to be compatible with the addressable LED strip 30 and configured to transmit the compatible output data electrical signal 560 to the addressable LED strip 30. The output data electrical signal 560 may further comprise one or more output data electrical signals in relation to the one or more fluids within the fluid column.

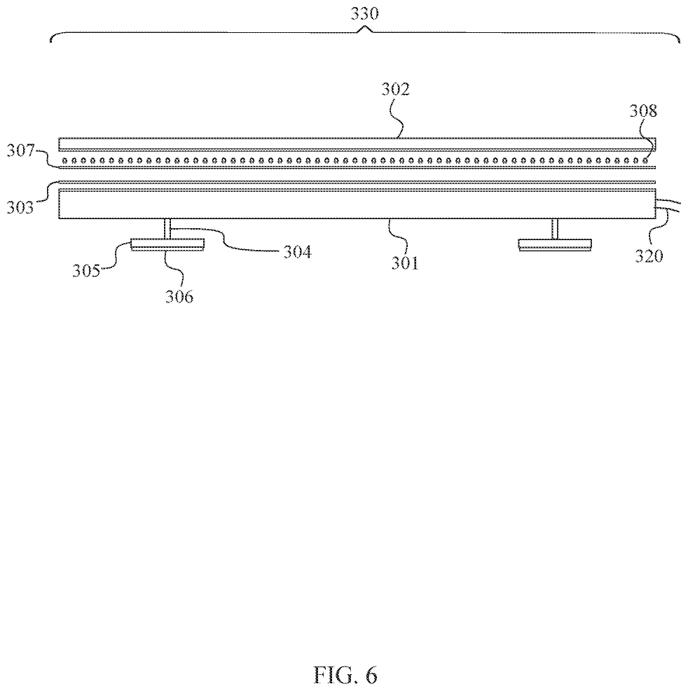

In accordance with some embodiments as shown in FIG. 1, FIG. 5, and FIG. 6, the addressable LED strip 30 may include a modular system 35 wherein the modular system 35 comprises one or more LED strip segments 330. One of the one or more LED strip segments 330 are electrically coupled to one of the one or more LED strip segments 330 by connection cables 320 for transmission of the output data electrical signal 560. The LED strip segments 330 are preferably configured in a linear arrangement. The addressable LED strip 30 further comprises a frame 301, and a lens 302. The frame 301 is preferably made of aluminum. The lens 302 is made of transparent material that allows emitted light to pass through. The lens material is preferably made of solid acrylic but is not limited to this. In the first preferred embodiment, the addressable LED strip 30 uses LEDs 308 for emitting light. The LEDs 308 may be configured to emit different colored lights such as white, blue, red, and green or the like without limit. The LEDs 308 are disposed on an LED printed circuit board 307 within the addressable LED strip 30. The addressable LED strip 30 provides a visual level notification of the fluid column. One of the one or more fluids can be assigned a color such as white, blue, red, and green or the like without limit.

In accordance with some embodiments, the addressable LED strip 30 is designed to be waterproof. The addressable LED strip 30 may include a frame seal 303 that seals the frame 301 and the lens 302 from allowing water between the said frame 301 and said lens 302. The frame seal 303 is disposed perimetrically around the frame 301. In some other embodiments, the frame 301 may comprise a first part of an interlocking lip. The lens 302 could comprise a second part of an interlocking lip. The interlocking lip is designed to channel water away from the LEDs 308 within the addressable LED strip 30. The frame 301 operably receives the lens 302 with the frame seal 303 disposed between the said frame 301 and said lens 302.

As shown in FIG. 1 and FIG. 5, the addressable LED strip 30 further comprises a tank mount 310. In some embodiments, the tank mount 310 may comprise a mounting arm 304, a mounting pad 305. The mounting arm 304 extends generally perpendicular from the addressable LED strip 30. The mounting pad 305 is attached to the mounting arm 304. The mounting pad 305 may be secured to the storage tank 100 by screws or rivets or the like. In some other embodiments, the storage tank 100 further comprises a storage tank support 110. The storage tank support 110 is a structure for strengthening the storage tank 100 and to support access stairs and pipe and the like. In the first preferred embodiment, the tank mount 310 further comprises a magnet 306. The storage tank 100 and storage tank support 110 are made of magnetic material. The magnet 306 is attached to the mounting pad 305. The addressable LED strip 30 can be secured to the storage tank 100 by attaching the tank mount 310 with the magnet 306 to the storage tank 100 or storage tank support 110.

According to some embodiments, the tank mount 310 may comprise a mount strap to secure the addressable LED strip 30 to the storage tank 100. The mount strap may further comprise a buckle or the like for securing ends of the mount strap together for securing the addressable LED strip 30 to the storage tank 100. The addressable LED strip 30 may include strap brackets mounted to the addressable LED strip 30. The strap brackets receive the mount strap.

In accordance with some embodiments, the present invention may include a motion sensor 90. The motion sensor 90 is positioned in operable proximity to the addressable LED strip 30. The motion sensor 90 is electrically coupled to the microcontroller 510 to transmit motion data. The motion sensor 90 helps conserve the electrical power. The addressable LED strip 30 will turn off after a pre-determined time has lapsed without detectable motion.

In some other embodiments, the present invention further comprises a light sensor 95. The light sensor 95 is electrically coupled to the microcontroller 510. The light sensor 95 is positioned in operable proximity to the addressable LED strip 30. The light sensor 95 can be configured to detect sunlight. When the sun goes down, the light sensor 95 will transmit the light data and the addressable LED strip 30 will dim light output from the LEDs 308 to conserve energy and limit light pollution of any surrounding area that may be affected by the light output.

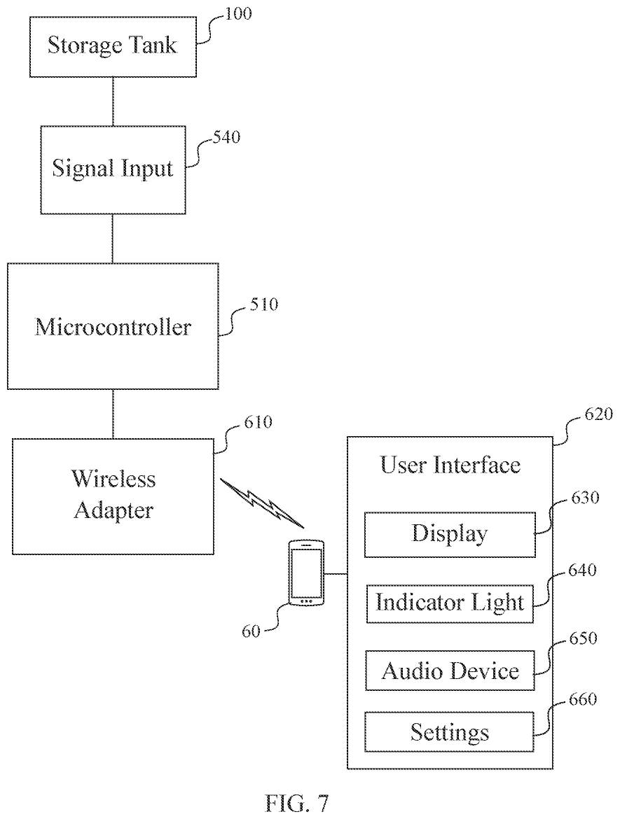

As shown in FIG. 7, the present invention further comprises a wireless adapter 610. The wireless adapter 610 is electrically coupled to the microcontroller 510 to transmit the output data electrical signal 560. The present invention further comprises of a monitoring app. The monitoring app can be installed on a mobile device 60 or computer. The mobile device 60 receives the output data electrical signal 560 transmitted from the microcontroller 510 via the wireless adapter 610. The monitoring app further comprises a user interface 620. The user interface 620 visually displays the output data electrical signal 560. The user interface 620 may visually present on the mobile device's display 630 a height of one of the one or more fluids, warning indications, and the like without limit. Warning indications may include when the fluid column within the storage tank 100 is too low or too high, or the like without limit, railroad warning notifications, valve open and close notification, temperature notifications and the like without limit. The warning indications may include flashing light indicators 640. The warning indicators may also include an audio electrical signal that emits from the mobile device's audio device 650 in the form of a beeping sound or the like. The monitoring app may also include settings such as setting the color for one of the one or more fluids, number of the LED strip segments 330 and the like. The warning indicators may also be transmitted to the addressable LED strip 30 where the addressable LED strip 30 may flash for pre-determined warning such as when the fluid column within the storage tank 100 is too low or too high.

Although the invention has been explained in relation to its preferred embodiment, it is to be understood that many other possible modifications and variations can be made without departing from the spirit and scope of the invention.

What is claimed is:

1. A material indicating gauge device comprises:
a housing;
a circuit;
an electrical power supply;
an addressable light emitting diode (LED) strip;
one or more cables;
the circuit is disposed within the housing;
the circuit is secured to the housing;
the circuit further comprises an LED driver,
a step-down converter,
a microcontroller,
the LED driver further comprises an input side, and
an output side;
the input side of the LED driver is electrically coupled to the electrical power supply by one of the one or more cables;
the output side of the LED driver is electrically coupled to the addressable LED strip;
the output side of the LED driver is electrically coupled to the step-down converter;
the step-down converter is electrically coupled to the microcontroller; and
the microcontroller is electrically coupled to the addressable LED strip.

2. The material indicating gauge device as claimed in claim 1 further comprises:
the addressable LED strip further comprises a frame,
a lens,
a frame seal;
the frame seal is disposed perimetrically around the frame; and
the frame receives the lens with the frame seal disposed between said frame and said lens.

3. The material indicating gauge device as claimed in claim 2 wherein the addressable LED strip is a modular system;
the modular system comprises one or more LED strip segments;
one of the one or more LED strip segments is electrically coupled together with one of the one or more LED strip segments; and
the LED strip segments are arranged in a linear arrangement.

4. The material indicating gauge device as claimed in claim 3 wherein the electrical power supply is an alternating current (AC) power supply; and
the circuit further comprises an AC to direct current (DC) converter;
the AC to DC converter is electrically connected to the electrical power supply and the input side of the LED driver.

5. The material indicating gauge device as claimed in claim 4 wherein an input data signal is transmitted to the microcontroller by one of the one or more cables;
the microcontroller transmits an output signal to the addressable LED strip by one of the one or more cables.

6. The material indicating gauge device as claimed in claim 1 further comprises:
a tank mount;
the tank mount further comprises a mounting arm,
a mounting pad,
a magnet;
the mounting arm extends perpendicular to the addressable LED strip;
the mounting pad is disposed on the mounting arm; and
the magnet is attached to the mounting pad.

7. The material indicating gauge device as claimed in claim 6 further comprises:
the housing further comprises a housing door,
a door latch,
a housing seal;
the housing door and door latch are engaged with the housing to enclose the circuit within the housing;
the door seal is disposed perimetrically around a peripheral edge of the housing; and
the housing operably receives the housing door with the housing seal disposed between said housing and said housing door.

8. The material indicating gauge as claimed in claim 1 further comprises a motion sensor;
the motion sensor is electrically coupled to the microcontroller; and
the motion sensor is positioned in operable proximity to the addressable LED strip.

9. The material indicating gauge as claimed in claim 8 further comprises a light sensor;
the light sensor is electrically coupled to the microcontroller; and
the light sensor is positioned in operable proximity to the addressable LED strip.

10. The material indicating gauge device as claimed in claim 1 further comprises:
a wireless adapter;
a mobile device;
a monitoring app;
the wireless adapter is electrically coupled to the microcontroller;
the mobile device configured to receive a wireless electrical signal;
the monitoring app further comprises a user interface.

11. A material indicating gauge device comprises:
a housing;
a circuit;
an electrical power supply;
an addressable light emitting diode (LED) strip;
one or more cables;
a tank mount;
the circuit is disposed within the housing;
the circuit is secured to the housing;
the circuit further comprises an LED driver,
a step-down converter,
a microcontroller,
the LED driver further comprises an input side, and
an output side;
the input side of the LED driver is electrically coupled to the electrical power supply by one of the one or more cables;
the output side of the LED driver is electrically coupled to the addressable LED strip;
the output side of the LED driver is electrically coupled to the step-down converter;
the step-down converter is electrically coupled to the microcontroller;
the microcontroller is electrically coupled to the addressable LED strip;
the addressable LED strip is a modular system;
the modular system comprises one or more LED strip segments;
one of the one or more LED strip segments is electrically coupled together with one of the one or more LED strip segments;
the LED strip segments are arranged in a linear arrangement;
the tank mount further comprises a mounting arm,
a mounting pad,
a magnet;
the mounting arm extends perpendicular to the addressable LED strip;
the mounting pad is disposed on the mounting arm; and
the magnet is attached to the mounting pad.

12. The material indicating gauge device as claimed in claim 11 further comprises:
the addressable LED strip further comprises a frame,
a lens,
a frame seal;
the frame seal is disposed perimetrically around the frame; and
the frame operably receives the lens with the frame seal disposed between said frame and said lens.

13. The material indicating gauge device as claimed in claim 12 wherein the electrical power supply is an alternating current (AC) power supply; and
the circuit further comprises an AC to direct current (DC) converter;
the AC to DC converter is electrically connected to the electrical power supply and the input side of the LED driver.

14. The material indicating gauge device as claimed in claim 13 further comprises:
the housing further comprises a housing door,
a door latch,
a housing seal;
the housing door and door latch are engaged with the housing to enclose the circuit within the housing;
the door seal is disposed perimetrically around a peripheral edge of the housing; and
the housing operably receives the housing door with the housing seal disposed between said housing and said housing door.

15. A material indicating gauge device comprises:
a housing;
a circuit;
an electrical power supply;
an addressable light emitting diode (LED) strip;
one or more cables;
the circuit is disposed within the housing;
the circuit is secured to the housing;
the housing further comprises a housing door,
a door latch,
a housing seal;
the housing door and door latch are engaged with the housing to enclose the circuit within the housing;
the door seal is disposed perimetrically around a peripheral edge of the housing;
the housing operably receives the housing door with the housing seal disposed between said housing and said housing door;
the circuit further comprises an LED driver,
a step-down converter,
a microcontroller,
the LED driver further comprises an input side, and
an output side;
the input side of the LED driver is electrically coupled to the electrical power supply by one of the one or more cables;
the output side of the LED driver is electrically coupled to the addressable LED strip;
the output side of the LED driver is electrically coupled to the step-down converter;
the step-down converter is electrically coupled to the microcontroller;
the microcontroller is electrically coupled to the addressable LED strip;
the addressable LED strip further comprises a frame,
a lens,
a frame seal;
the frame seal is disposed perimetrically around the frame;
the frame operably receives the lens with the frame seal disposed between said frame and said lens;
the addressable LED strip is a modular system;
the modular system comprises one or more LED strip segments;
one of the one or more LED strip segments is electrically coupled together with one of the one or more LED strip segments; and
the LED strip segments are arranged in a linear arrangement.

16. The material indicating gauge device as claimed in claim 15 further comprises:
a tank mount;
the tank mount further comprises a mounting arm,
a mounting pad,
a magnet;
the mounting arm extends perpendicular to the addressable LED strip;
the mounting pad is disposed on the mounting arm; and
the magnet is attached to the mounting pad.

17. The material indicating gauge device as claimed in claim 15 wherein the electrical power supply is an alternating current (AC) power supply; and
the circuit further comprises an AC to direct current (DC) converter;
the AC to DC converter is electrically connected to the electrical power supply and the input side of the LED driver.

18. The material indicating gauge as claimed in claim 17 further comprises a motion sensor;
the motion sensor is electrically coupled to the microcontroller; and
the motion sensor is positioned in operable proximity to the addressable LED strip.

19. The material indicating gauge as claimed in claim 18 further comprises a light sensor;
the light sensor is electrically coupled to the microcontroller, and the light sensor is positioned in operable proximity to the addressable LED strip.

20. The material indicating gauge device as claimed in claim 19 further comprises:
a wireless adapter;
a mobile device;
a monitoring app;
the wireless adapter is electrically coupled to the microcontroller;
the mobile device configured to receive a wireless electrical signal;
the monitoring app further comprises a user interface.
